(19) United States
(12) Patent Application Publication
(10) Pub. No.: US 2010/0287191 A1
(43) Pub. Date: Nov. 11, 2010

(54) TRACKING AND RETRIEVAL OF KEYWORDS USED TO ACCESS USER RESOURCES ON A PER-USER BASIS

(75) Inventors: Richard Price, San Francisco, CA (US); Ben Lund, San Francisco, CA (US)

Correspondence Address: Virtual Law Partners LLP, 555 Bryant Street, Suite 820, Palo Alto, CA, 94301, US

(73) Assignee: ACADEMIA INC., San Francisco, CA (US)

(21) Appl. No.: 12/774,654

(22) Filed: May 5, 2010

Related U.S. Application Data
(60) Provisional application No. 61/175,671, filed on May 5, 2009.

(51) Int. Cl. G06F 17/30

(52) U.S. Cl. 707/769; 707/E17.014

(57) ABSTRACT

The information about where a request for a resource originated can provide useful feedback to the individual or organization that published the resource. When this information includes the keywords input to a search engine, through which the resource is then accessed, these keywords can be provided to the user that published the resource. The user can receive a notification, such as an electronic mail message, indicating the keywords and search engine used to access the resource. A database of such accesses and related keyword information can be stored on a per-user basis. This database can provide feedback indicating how the resources of the user are being located through search engines.

### CLAIM OF PRIORITY

This application claims benefit of priority to U.S. provisional application Ser. No. 61/175,671, filed May 5, 2009, which application is incorporated herein by reference in its entirety.

### TECHNICAL FIELD

The technology disclosed herein relates generally to keyword searches performed over the Internet, and more specifically to providing information about searches to those users whose content is located as a result of a search.

### BACKGROUND

Individuals and organization (hereinafter “users”) commonly publish content, such as articles, blogs, text, and other resources (hereinafter “resources” generally), on the Internet. When a resource is made available on the Internet, it is given a uniform resource locator (URL), which other computers can use to access the resource. Such resources commonly are indexed by various search engines. Individuals and computers can perform searches using such search engines, which retrieve URLs for resources that match a set of search terms, also called keywords. When a computer accesses a URL on the Internet, the request is in the form of a hypertext transfer protocol (HTTP) message or a message in a similar protocol. Such messages typically include information about where the request originated.

### SUMMARY

The information about where a request for a URL originated can provide useful feedback to the individual or organization that published the resource accessed using the URL. When this information includes the keywords input to a search engine, through which the resource is then accessed, these keywords can be provided to the user that published the resource. The user can receive a notification, such as an electronic mail message, indicating the keywords and search engine used to access the resource. A database of such accesses and related keyword information can be stored on a per-user basis. This database can provide feedback indicating how the resources of the user are being located through search engines.

### DESCRIPTION OF DRAWINGS

FIG. 1 is a block diagram of an example system for providing information about search terms to users regarding searches performed to access the users' content.

FIG. 2 is an example implementation of how keywords are extracted from a referring URL.

FIG. 3 is an example of a search engine database.

FIG. 4 is a flowchart describing the operation of FIG. 2.

FIG. 5 is an example of the keyword database structure.

FIG. 6 illustrates an example keyword page.

FIG. 7 is a flowchart describing a process for generating a keyword page.

FIG. 8 is a block diagram of another embodiment.

FIG. 9 is a flowchart describing operation of another embodiment.

### DETAILED DESCRIPTION

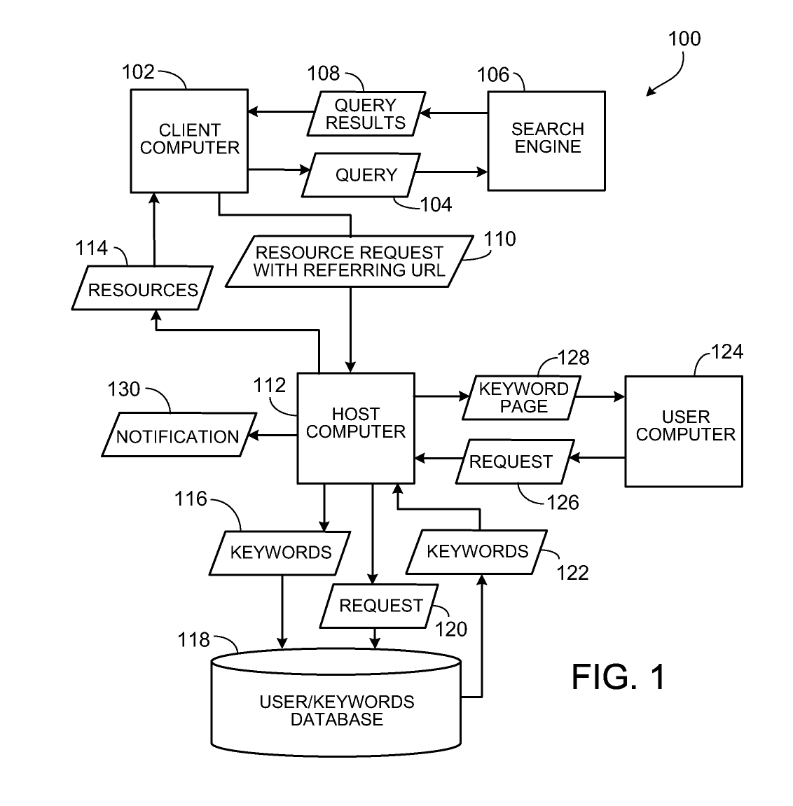

FIG. 1 is a block diagram of an example system 100 for providing information about search terms to users regarding searches performed to access the users' content.

In FIG. 1, and other block diagrams, elements represented by a parallelograms designate data, and elements represented by rectangles designate processing elements, which typically are implemented by conventional computer hardware, including a processor executing instructions of a computer program with appropriate input devices, output devices and memory. The designation of different processing elements by different rectangles does not signify that the processing elements need be implemented using different computer hardware. Lines between data and processing elements designate any form of transmission of the data between the processing elements. The data may be stored in computer readable memory that is accessed by the processing elements.

This system 100 can operate over a computer network, such as the Internet, and includes one or more client computers 102, each of which connects to the computer network. A client computer 102 may be, for example, a personal computer, a business desktop computer, a handheld computer or mobile communication device or other device enabling content retrieval and viewing. The client computer typically includes browser software (not shown) that provides a user with the ability to access and view documents over the computer network.

Through the client computer 102, a user may submit a query 104 to a search engine 106. The search engine is usually a publicly accessible search service that can be accessed over a computer network, such as the Internet, and includes, but is not limited, search engines such as the Google, Yahoo, AOL, MSN and other similar search engines. Such a search engine 106 returns query results 108. The query results typically include a list of resources that have been indexed by the search service, along with information that can be used to access the resource over the computer network. Such information typically is a “uniform resource locator” or URL.

The query results 108 are typically displayed at the client computer 102 to a user, who can select one or more of the resources to access the selected resources. The browser software of the client computer may issue a resource request 110 over the computer network to a host computer 112 which stores the selected resource. The host computer 112, in response to the request, provides the selected resource 114 back to the client computer 102. The host computer 112 can be of the form of computers that typically include web server software that provides the ability to serve up content to other computers in response to requests received over the computer network.

Using the Internet, the client computer 102 would issue the resource request 110 typically using messages conforming to the Hypertext Transfer Protocol (HTTP). The resource request 110, when generated in response to a user selecting a resource from a set of search results, typically includes both the URL for the selected resource and a URL called a “referring URL,” which is the URL of the resource containing the URL for the selected resource. When the referring URL identifies a resource which is a result of a search, the referring URL typically indicates the search terms used in the search. The format of the referring URL is described in “Uniform Resource Locators (URL): A Syntax for the Expression of Access Information of Objects on the Network” by Tim Berners-Lee, available at www.w3.org/Addressing/URL/url-spec.txt, the content of which is hereby incorporated by reference. For example, a referring URL resulting from a search on a search engine (“searchengine”) for “find tension between two objects” might take the form:

http://search.searchengine.com/search?ei=UTF-8&y=Search&fr=yfp-t-
313&p=find+tension+between+two+objects&rs=0&fr2=rs-top

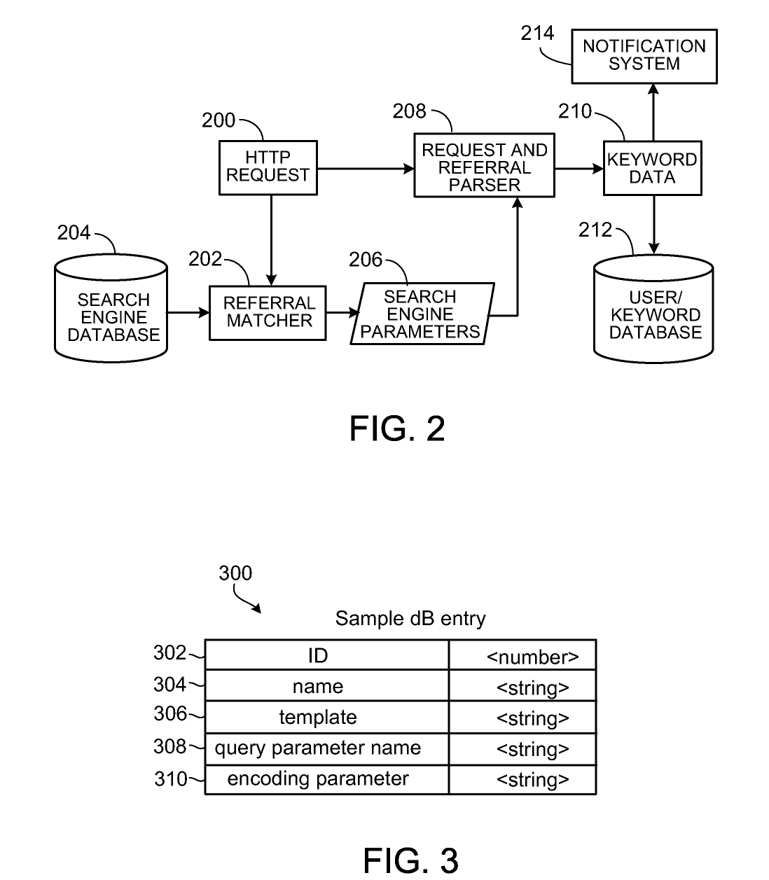

The host computer 112 receives the referring URL and processes it to extract the keywords 116, and stores them, along with other information about the referring URL, in a user/keyword database 118, in association with information about the selected resource 114. The extraction of the keywords is described in more detail hereinbelow in connection with FIGS. 2-4. For example, the keywords may be stored in association with the URL of the selected resource, or may be stored in association with an author of the resource 114, or may be stored in association with a collection of resources containing the resource 114.

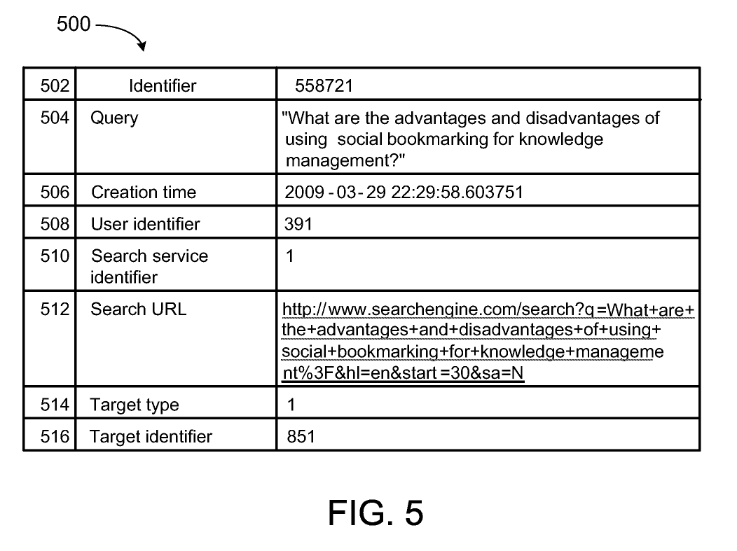

For example, given the example referring URL above, the host computer 112 may store in a database the keyword string “find tension between two objects”, the search engine “searchengine,” and the date and time the resource 114 was accessed, and information identifying resource 114, or its author, or a collection containing resource 114. Example content of an example database is provided in more detail in connection with FIG. 5.

The storage of this keyword information enables authors of resources 114 to learn which keywords are being used to access their content, and which search engines are being accessed, along with other useful information about how others are locating the authors' content.

The keyword information 116 also can be included in a notification 130 that is send by the host computer 112 to the user who published the resource. Such a notification can be, for example, an electronic mail message. The notification can be generated using a template, an example of which is the following:

Subject: Someone just searched for you on [Search Engine]...
Hi [User],

Someone just searched for you on [Search Engine], and found your page on [Host Computer]. The search term they used was:

“[Extracted Keywords]”
To see all your keywords, follow the link below.
http://[host.computer]/[user.name]/Keywords
To delete this keyword from your Keywords page, simply follow link below:
http://[host.computer]/[user.name]/DeleteKeyword/[keyword.identifier]

In the message template above, the reference to a “Keywords” resource is described hereinbelow. The message above provides a link to another resource that accesses a program that receives the identifier of a keyword entry in the keyword database (described hereinbelow) and allows that keyword entry to be deleted.

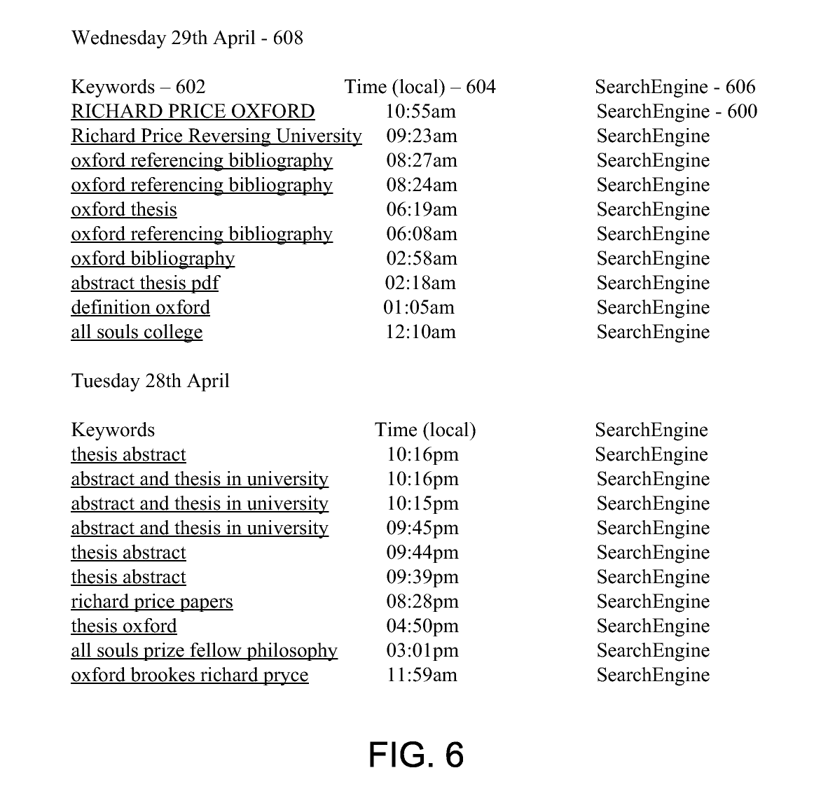

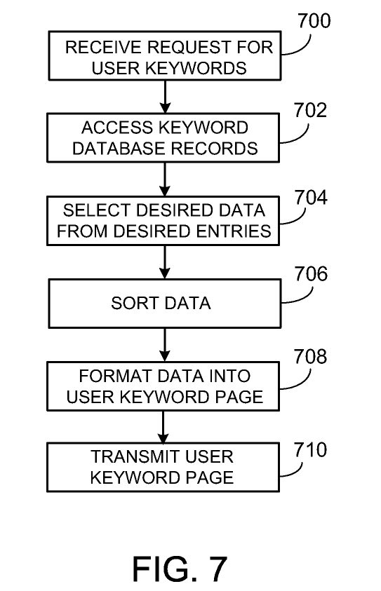

One example of how the user keyword database 118 can be used is the following. A keyword resource (not shown) can be defined at the host computer 112. It may have a URL of the form http://[host.computer]/[user.name]/Keywords. A user at a user computer 124 may send, to the host computer 112, a request 126 for this keyword resource. In response, the host computer 112 issues a request 120 to the keyword database 118 to access all of the keyword records 122 associated with an author [user.name]. If each author that publishes content on the host computer has a user name such a “[user.name]” in the URL form above, and a path such as “http://[host.computer]/[user.name]/” under which all resources published by that author is located. If each author has an associated user identifier, then these pieces of information can be used to track all keyword data used to access the author's resources in the keyword database. The host computer processes the keyword records 122 to generate a keyword page 128 describing the keyword records 122. The creation of such a keyword page 128 is described in more detail hereinbelow in connection with FIGS. 6 and 7. This keyword page can be published by the author so it can be accessed by anyone, not just the author.

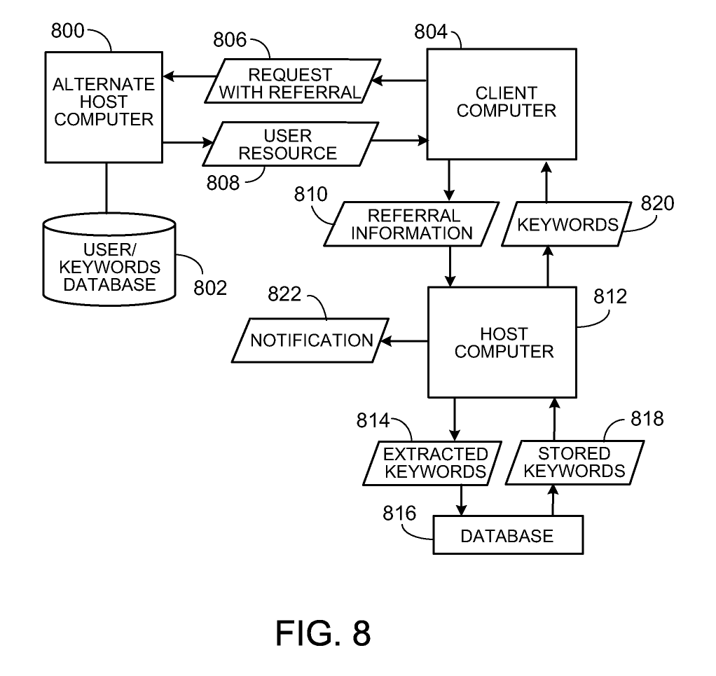

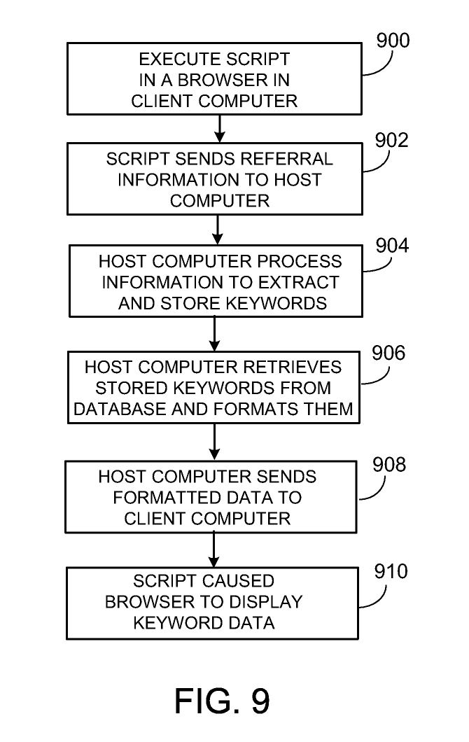

An alternative embodiment for tracking keywords and generating keyword pages is described in more detail hereinbelow in connection with FIGS. 8 and 9.

Referring now to FIG. 2 an example implementation of how keywords are extracted from a referring URL will now be described.

In FIG. 2, an HTTP request 200 is received by a referral matcher 202. The referral matcher accesses a search engine database 204 which includes records describing the formats used by various search engines for referring URLs.

An example of such a database is described in more detail in connection with FIG. 3. In particular, the database 204 includes, for each search engine, an entry 300 that includes: an identifier 302 for a search engine, represented by a number; a name 304 of the search engine, represented by a string; a template 306 describing the format of a referring URL used by the search engine, represented by a string defining a regular expression template for matching URLs that represent searches from that search engine; the name 308 of the parameter in the referring URL that designates the query terms, represented by a string; and the name 310 of the parameter in the referring URL that designates the character encoding, if any, of the search terms used in the referring URL.

Example values for commonly available search engines are as follows:

| id: | 1 |
|---|---|
| name: | Google |
| template: | (?-mix:\hat{ }http:\/\/(www\.)?google.*) |
| query_param: | q |
| encoding_param: | ie |
| id: | 2 |
| name: | Yahoo |
| template: | (?-mix:\hat{ }http:\/\/search\.yahoo.*) |
| query_param: | P |
| encoding_param: | ei |
| id: | 3 |
| name: | MSN |
| template: | (?-mix:\hat{ }http:\/\/search\.msn.*) |
| query_param: | q |
| encoding_param: | [none] |
| id: | 4 |
| name: | AOL |
| template: | (?-mix:\hat{ }http:\/\/search\.aol.*) |
| query_param: | userQuery |
| encoding_param: | [none] |

The referral matcher 202 matches the received referring URL from the HTTP request 200 against the templates in the database 204 and outputs the parameters 206 associated with the search engine whose entry matches. The HTTP request 200 and the search engine parameters 206 are provided to a request and referral parser 208, which, using the template and the query and encoding parameters from the parameters 206, extracts the keyword data 210 from the referring URL. Example source code for implementing such a parser is provided in the Appendix hereto. During the parsing of the referrer URL, the character encoding of the query also is normalized, if possible. If the search terms contain non-ASCII, i.e., international, characters, they could be provided in a variety of different encodings, e.g., “ISO-8859-1” or “ISO 8859-7”). The search engine may specify which encoding is being used in the encoding parameter. If so, the system converts from that encoding into a standard UTF-8 encoding for storage in the database. This normalization ensures that all search terms are normalized as the same encoding in the database. The keyword data 210 is then stored in the keyword database 212 (also 118 in FIG. 1). The keyword data 210 also is used by a notification system 214 that generates the notification (such as at 130 in FIG. 1), for example by completing the template described hereinabove.

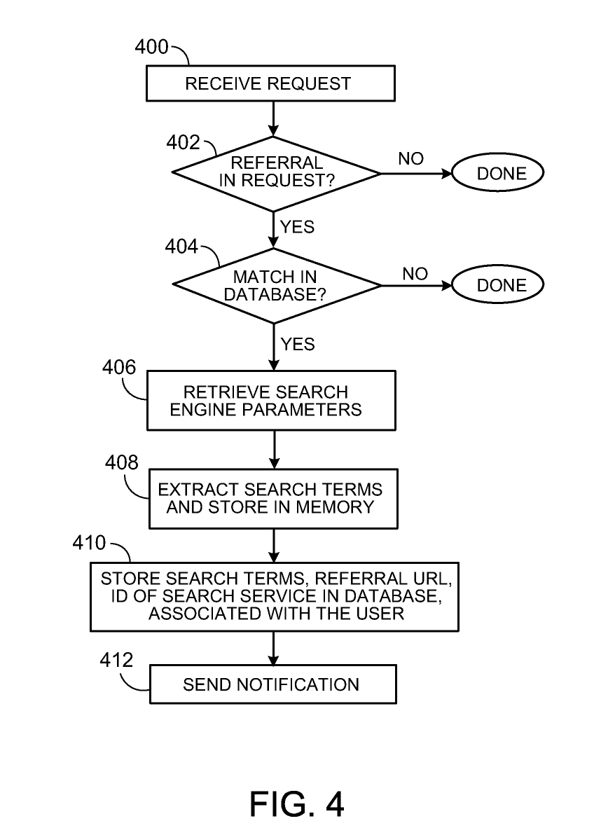

A flowchart describing the operation of FIG. 2 will now be described in more detail in connection with FIG. 4.

An HTTP request is received 400. It is determined 402 if the request includes referring URL. If not, then no further processing of the referring URL is performed and the requested resource can be provided to the requestor. If a referring URL is in the request, then it is matched 404 against the search engine database. If there is no match, then no further processing of the referring URL is performed and the requested resource can be provided to the requestor. If there is a match, then the search engine parameters are retrieved 406 from the data search engine database. The search terms are extracted 408 from the referring URL using the search engine parameters, then stored in memory. The search terms along with other information, then are stored 410 in the keyword database.

The system also may send 412 a notification, such as an electronic mail message or other communication, to the user responsible for the resource, indicating that a search caused the resource to be accessed. This email may include, for example, the keywords used to access the resource as noted above.

An example of the keyword database structure is illustrated in FIG. 5. Each search event generates a record 500 that includes an identifier 502, which is an internal identifier for the search event. In this example, the identifier is “558721”. The query 504 is the extracted search terms, or keywords. In this example, the search terms are “What are the advantages and disadvantages of using social bookmarking for knowledge management?”. The creation time 506 is a timestamp for when the search event happened; in this example, “2009-03-29 22:29:58.603751”. A user identifier 508 is an internal identifier for the author whose resource was accessed through the search terms. This example shows user “391” as the author. The search service identifier 510 is a reference to an identifier in the search engine database, indicating the search service in the referring URL; in this example, “X”, indicating a “search engine,” depending on the contents of the search engine database. The original referring URL is stored as the search URL 512. The target type 514 indicates whether the search landed on a particular type of resource. For example, a research paper may be a type, identified by the number “1”. A target identifier 516 provides a unique identifier for this resource, given its type. For example, an identifier of 851 and type of 1 would indicate that paper number 851 was accessed. There could be multiple different types of targets (such as presentations, papers, audio files, blog pages, etc., each instance of which can have an identifier.

Given the keyword database, a variety of different views on the information can be provided. In general, a resource can be defined that selects from among the various entries, such as by user identifier, and then sorts, formats and displays the selected entries. An example of such a display is shown in FIG. 6. The example shown in FIG. 6 illustrates a selection of keyword entries 600, sorted by creation time. Each entry provides the keywords 602, the time 604 and the search service 606. The keywords, when displayed by a browser, may actually represent a hyperlink that is the URL of the original search query through which the resource was identified. In this example, the creation time data can be processed to separate the date 608 from the time, to allow the display to be segregated by date.

Sample HTML source code for a keyword entry in the keyword listing is provided hereinbelow:

<div class=‘referer-query’>

<a href=“http://search.searchengine.com/search?ei=UTF-
8&y=Search&fr=yfp-t-
313&p=find+tension+between+two+objects&rs=0&fr2=rs-top”>find
tension between two objects</a>
</div>

<div class=‘referer-time’>

06:19am
</div>

<div class=‘referer-service’>

SearchEngine
</div>

A flowchart describing an example process for generating the keyword page will now be described in connection with FIG. 7. A request for the keywords is received 700. The host computer accesses 702 the keyword database, to obtain the desired entries. Any of the fields in the database may be used to select the data. As an example, assume that a user identifier has been provided to select the desired entries. The desired data is then selected 704 from the desired entries. For example, a subset of the fields in each entry may be retrieved, such as the keywords, search service identifier, referring URL and timestamp. The selected data is then sorted 706. For example, the data may be sorted by date and time. The data is then formatted 708. For example, each entry may be formatted using the HTML example given hereinabove. The formatted data then may be transmitted 710 to the requestor.

Having now described one embodiment in which the resource retrieval and the keyword processing are performed at the same host computer, another embodiment will now be described in connection with FIGS. 8 and 9. In this embodiment, the resource being retrieved is accessed through a server computer that is different from the computer that maintains the keyword database. More generally, this resources that is retrieved may be located on any server on the computer network (such as, any server on the Internet) and need not be controlled by the same computer as the keyword database.

In FIG. 8, an alternate host computer 800 provides that access to user resource(s) 802. This alternate host computer 800 may be any server on the Internet that makes resources available to other users. A client computer 804 issues a request 806 for a resource, which request may include a referral URL. The alternate host computer accesses the requested resource, and provides the user resource 808 to the client computer 804. The author of the resource embeds a computer program, such as a JavaScript program, in the resource. A unique identifier is provided for each author that uses an instance of this computer program, which is embedded in the computer program and which is associated with that author's user identifier (508 in FIG. 5). Any number of resources can be embedded with this computer program by the author. This program is executed by the browser in the client computer 804 when it displays the resource to the user. The computer program sends the URL of the resource and the referring URL (collectively, referral information 810), along with its unique identifier, to the host computer 812. It is possible that the referring URL may be blank, or that the referring URL may not be from a search engine and may not include keywords. The host computer 812 then processes the information in the same manner as in the embodiment hereinabove to extract and store keywords 814, if any, in the database 816. In the database, the URL of the resource is associated with the user associated with the unique identifier of the computer program embedded in the resource. The host computer 812 also may send a notification, similar to notification 130 described hereinabove in connection with FIG. 1. The host computer then selects all of the relevant keyword entries and formats them (in the same manner as indicated at 122 and 128 in FIG. 1), to provide these keywords to the client computer 804. In this embodiment, the keywords selected are those associated with the selected resource.

FIG. 9 is a flowchart describing the operation of FIG. 8. The browser in the client computer executes 900 a script embedded in a resource. The script sends 902 referral information to the host computer. The host computer processes 904 the information to extract and store keywords. The host computer retrieves 906 the stored keywords from the database, selects those keywords associated with the resource being displayed at the client computer, and formats the keywords. The host computer sends 908 the formatted keywords to the client computer. The script then causes 910 the browser to display the formatted keywords.

Using these methods, the author of content or provider of various resources on a computer network can learn what searches are being used by others to locate their information.

The methods described herein can be implemented in digital electronic circuitry or in computer hardware, executing appropriate firmware or software, or in combinations of them. The methods can be implemented as a computer program product, i.e., a computer program tangibly embodied in a machine-readable storage device, for execution by, or to control the operation of, data processing apparatus, e.g., a programmable processor, a computer, or multiple computers. It is to be understood that such a computer program product does not encompass signals of a transient nature. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Steps of the methods described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Processing elements in the figures can refer to portions of a computer program and/or the processor/special circuitry that implements that functionality described for that processing element.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Machine readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The computing system can include clients and servers. A client and server are generally remote from each other and typically interact over a communication network. The relationship of client and server arises by virtue of computer programs running on the respective computers and having a client-server relationship to each other.

APPENDIX
def setup_search_referer

unless referer.blank? ## only run if there's a referer present

query_args =

begin

URI.split(referer)[7] ## parse the referer URL with a standard library, and extract the

query string

rescue URI::InvalidURIError

nil

end

search_services.each do |ss| ## loop through all the search services we know about

if (ss.match(referer)) && !query_args.blank?

## For each one, check whether the search services template matches the referer

unescaped_keywords = nil
encoding = nil

## Look at all the parameters in the query string

query_args.split(“&”).each do |arg|

pieces = arg.split(‘=’)
if (pieces.length == 2)

if (pieces.first == ss.query_param) ## If this is the search query parameter, save its

value

unescaped_keywords = pieces.last

elsif !ss.encoding_param.blank? && (pieces.first == ss.encoding_param)

## If this is the character encoding query parameter, save its value

encoding = pieces.last

end

end

end
if !unescaped_keywords.blank? ## if we found a query, unescape and convert its

encoding

begin

unstopped_keywords = valid_utf8( CGI.unescape(unescaped_keywords), encoding )
referring_search = unstopped_keywords.squeeze(‘ ’)

## cleans up the extracted keywords by removing duplicate spaces

unless referring_search.blank?

@search_referer_attributes = {:query => referring_search, :search_service_id =>

ss.id,: search_url => referer} ## stores the extracted keywords in memory for later
augmentation and saving

end

rescue Exception => e

## probably an encoding conversion error -- don't worry about it, just don't log the

referer

end

end

end

end

end
true

end

A number of embodiments of the invention have been described. Nevertheless, it will be understood that various modifications may be made without departing from the spirit and scope of the invention. Accordingly, other embodiments are within the scope of the following claims.

1. A computer-implemented process, comprising:
receiving in a memory device information describing a referring resource associated with a request for a resource, wherein the information may include keywords;
processing, using a processor, the request to extract the keywords;
storing the keywords in a database in association with a user associated with the resource

2. The computer-implemented process of claim 1, further comprising notifying the user of the request.

3. The computer-implemented process of claim 1, further comprising:
executing computer program instructions embedded in the resource to extract the information describing the referring resource; and
transmitting the information to the processor.

4. The computer-implemented process of claim 1, further comprising:
receiving in a memory device the request for the resource; and
extracting the information describing the referring resource from the request for the resource.
